(19) United States
(12) Patent Application Publication
(10) Pub. No.: US 2023/0225261 A1
(43) Pub. Date: Jul. 20, 2023

(54) BREATHABLE REFLECTIVE COVER FOR HYDROPONIC OR AEROPONIC GROW APPARATUS

(71) Applicant: Margaret Williams, Iron Mountain, MI (US)

(72) Inventor: Margaret Williams, Iron Mountain, MI (US)

(21) Appl. No.: 17/578,634

(22) Filed: Jan. 19, 2022

(51) Int. Cl. A01G 31/02; A01G 13/02

(52) U.S. Cl. CPC A01G 31/02; A01G 13/0206

(57) ABSTRACT

A breathable reflective cover for hydroponic or aeroponic grow apparatus is devised to cover an extant standalone grow unit. The cover comprises a porous fabric matrix that serves to subdue the illuminance emitted by the grow unit during use while enabling gaseous exchange with the surrounding atmosphere. The cover enables easy access to plants grown in the grow unit while protecting the plants from external influences, including pets.

### TO ALL WHOM IT MAY CONCERN

Be it known that I, Margaret Williams, a citizen of the United States, have invented new and useful improvements in a breathable reflective cover for hydroponic or aeroponic grow apparatus as described in this specification.

### BACKGROUND OF THE INVENTION

Modern lighting technology has enabled production of edible plants in the home a viable means of producing food for the family. Lighting systems that consume low power and emit light in wavelengths suited for plant growth are readily available, and a number of systems have been developed that enable easy growth of various herbs and vegetables interior to a self-contained unit. These systems opt for hydroponic or aeroponic rooting; that is, use of soil is generally mitigated. Since many of these systems are designed for use indoors in apartments and houses, hydroponic and aeroponic systems tend to avoid mess during ordinary use that otherwise may occur when using soil as a rooting matrix. Further, hydroponic and aeroponic systems allow for regular, convenient, and in some cases, automated fertilizing administrable when watering, for example.

Since such systems are designed for use in an enclosed space, a problem arises where the illuminance of the grow lights becomes a nuisance to occupants in the vicinity, especially over maximized growing cycles. What is needed is a cover that is adapted for use with these standalone grow units and systems, devised to subdue the brightness of light emitted exterior to the cover while remaining porous to atmosphere to control overheating. Further, the cover may include a reflective interior to focus and concentrate the light to increase vegetative production of the grow unit.

### FIELD OF THE INVENTION

The present invention relates to a cover particularly devised for use with a standalone grow unit of a type frequently employed for indoor usage. The present invention, therefore, relates to an attachable, breathable and reflective cover for hydroponic or aeroponic grow apparatus that is devised to fit to a preexisting, standalone grow unit to shield the luminescence interior to the cover while maintaining easy access to the plants grown in the grow unit and throughflow of air, and, in some embodiments, increased vegetative growth due to reflection of the light interior to the cover.

### SUMMARY OF THE INVENTION

The present invention has been devised to enable convenient covering of a standalone grow unit of the type typically used indoors. While indoors usage is associated with the preferred embodiment set forth herein, it should be evident to persons having ordinary skill in the relevant art that the present invention is usable in like capacity outdoors.

Various standalone grow units continue to appear on the market. Such units typically embody an all-in-one facility to plant, germinate, grow, and harvest plants. The units typically include a chamber or capacity in which to grow the plants, some sort of overarching structure or frame to position grow lights, and a reservoir for the storage and disposition of nutrients or growth medium as case may be. Many of these units are devised for use indoors, to enable small scale production of homegrown herbs and vegetables and enable a user to have fresh ingredients on hand when cooking.

The general intent of the present invention, therefore, is to enable covering a standalone grow unit and the plants grown therein, to shield and protect the plants grown, and also to mute the illuminance of the grow lights to an outside observer. The cover serves both as a barrier or shield, to protect the plants from exterior stresses and from contact with pets (especially cats, which are notoriously inquisitive of such apparatuses when used indoors), and as a means by which to mute the brightness of the grow lights while enabling translucence and porosity for gaseous exchange with ambient atmosphere.

To mute the light emitted, while covering and containing the grow unit and plants therein, the material from which the cover is devised is to some degree translucent, enough to enable a user to still see the plants inside, but in a muted capacity whereby the brightness of the grow lights operative in the standalone unit is subdued. The light emitted, which may be operative for 18 hours or more a day to maximize vegetative growth, can become a nuisance to users, especially where the grow unit is employed in an apartment or a bedroom. By muting the illuminance from the perspective of an outside observer, the instant cover prevents the grow unit from becoming a nuisance and a user may increase the hours the unit is active to maximize growth of the plants therein.

The instant cover is devised to be porous to enable the passage of air, to prevent overheating or the development of unfavorable levels of relative humidity, for example. In a preferred embodiment, the porosity of the material is the means by which translucence of the cover is effectuated. That is, the cover is translucent as a result of the pores in the fabric material rather than some intrinsic property of the material comprising the fabric itself. In other words, the cover may still be translucent to some degree despite being woven or manufactured from an opaque or reflective fiber.

The cover is devised to enable easy access to the interior space partitioned within, while covering and enclosing the apparatus and plants with which the apparatus is used. The fabric used is lightweight, and the cover may be readily removed from the grow unit. In some embodiments, the cover includes an openable seam upon a front side whereby the cover is openable and the plants therein are accessible by simple manual action. In such embodiments, the cover remains secured or anchored to the grow unit while access to the plants and grow unit is permitted, for ease of watering, harvesting, maintenance, and care.

The cover is adapted or configured specifically to secure or anchor to or around the standalone grow unit and may accommodate vertical extension of the grow unit as the lighting array is necessarily raised to accommodate the growth of the plants grown in the grow unit. Often, such units that are devised for indoor use employ low heat lighting, such as fluorescent or LED lights. Such lights frequently have low incidences of illuminance (luminous flux per unit area) and luminous exitance whereby closer proximity to growing plants is preferred to stimulate healthy growth and prevent etiolation. Such lighting systems are preferable in many instances because of the lower heat produced as well as the lower power consumed. Hence, some units employ a moveable lighting assembly or array that is vertically extendible as the plants grow. The instant cover is devised, therefore, at least in some embodiments, to accommodate such extension of the lighting array for use with such units as require it. Rendered of fabric, the cover may be sized to fit the unit in the unit's extended position whereby excess fabric may be gathered around a lower hem when the cover is first fit to the unit in its non-extended position. During use, as the lighting array is extended, the cover may be lifted to accommodate the extension until the cover presents no excess fabric gathered at the lower hem and the unit is maximally extended.

Discussing now the preferred embodiments, the present breathable reflective cover for hydroponic or aeroponic grow apparatus, includes a porous fabric matrix having an open bottom. The porous fabric matrix may be manufactured from spun polypropylene. Spun polypropylene is lightweight and exhibits porosity between the woven fibers for translucence and movement of atmosphere. The porosity serves to enable gaseous exchange throughout the interior of the cover with the ambient environment while mitigating the brightness of the grow lights in use of the grow unit. Polypropylene is, as a material, generally impervious and nonporous, so it will not absorb water and is conveniently wipe-clean.

The cover further includes a reflective surface disposed upon an interior side of at least a front and rear side of the cover. In a preferred embodiment set forth here, the reflective surface may be manufactured from a polyester film such as biaxially-oriented polyethylene terephthalate (“BoPET” or “Mylar®”). Right and left sides of the cover may be covered with a reflective surface or rendered without the reflective surface to increase porosity of the cover and maximize throughflow of ambient air. In some embodiments, the BoPET interior surface may be metalized by vapor deposition of a thin film of evaporated aluminum or other suitable metal, to increase reflectivity up to 99% of light.

In some embodiments contemplated herein, the cover includes at least one elasticized member disposed in operational communication with the open bottom by which the cover may be anchored or secured to the grow unit. The at least one elasticized member may be incorporated interior to a lower hem surrounding the open bottom, whereby the open bottom is itself elasticized and drawn taught around a base of the grow unit. Alternatively, the at least one elasticized member may be strung between opposing sides of the lower hem end to end, whereby the at least one elasticized member runs underneath the base of the grow unit and maintains the cover in place.

For ease of access interior to the cover, to access, harvest, and tend the plants grown therein, the cover may include an openable seam bounding at least a portion of the front side. The openable seam is devised to enable the front side to be pulled down, or away from conjunction with at least two or three of the top, left, right sides, and/or lower hem. In a preferred embodiment, the openable seam is secured in a closed position by action of hook and loop fasteners and may therefore be opened and closed manually. Alternative means of effectuating closure of the openable seam are contemplated as within the scope of this disclosure, including, but not limited to, zippers, snaps, buttons, ties, zip-lock closure, or other known or reasonably discernible means of mating one seam to another.

Thus has been broadly outlined the more important features of the present breathable reflective cover for hydroponic or aeroponic grow apparatus so that the detailed description thereof that follows may be better understood and in order that the present contribution to the art may be better appreciated.

Objects of the present attachable cover for hydroponic or aeroponic grow apparatus, along with various novel features that characterize the invention are particularly pointed out in the claims forming a part of this disclosure. For better understanding of the attachable cover for hydroponic or aeroponic grow apparatus, its operating advantages and specific objects attained by its uses, refer to the accompanying drawings and description.

### BRIEF DESCRIPTION OF THE DRAWINGS

### Figures

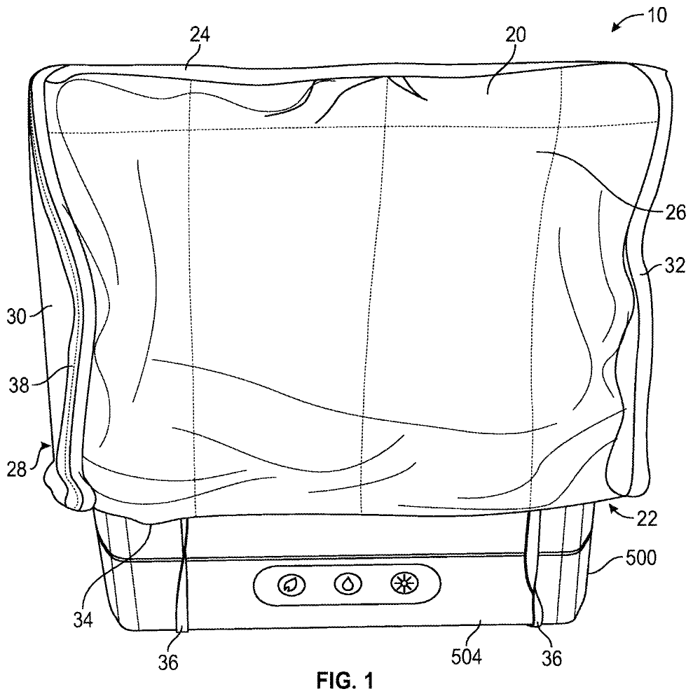

FIG. 1 is a front elevation view of an example embodiment of the cover installed to an exemplary standalone grow unit.

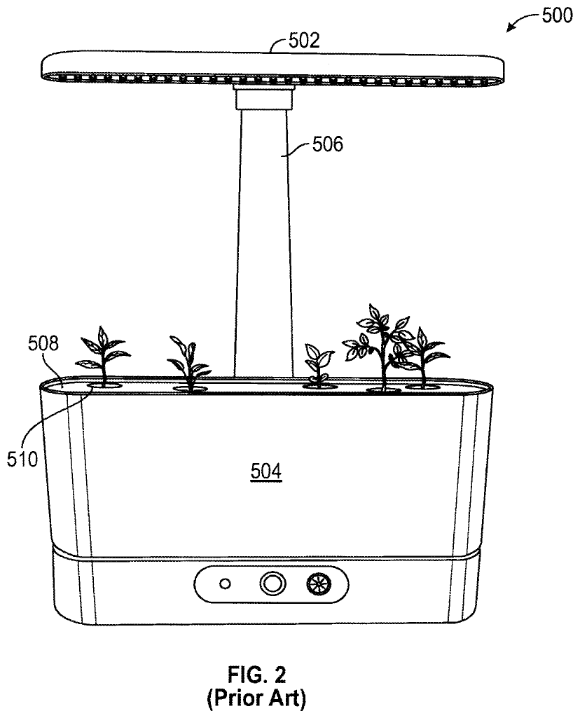

FIG. 2 is a front elevation view of an example embodiment of an existing, prior art standalone grow unit with which the cover is used. The existing standalone grow unit is not part of the instant invention.

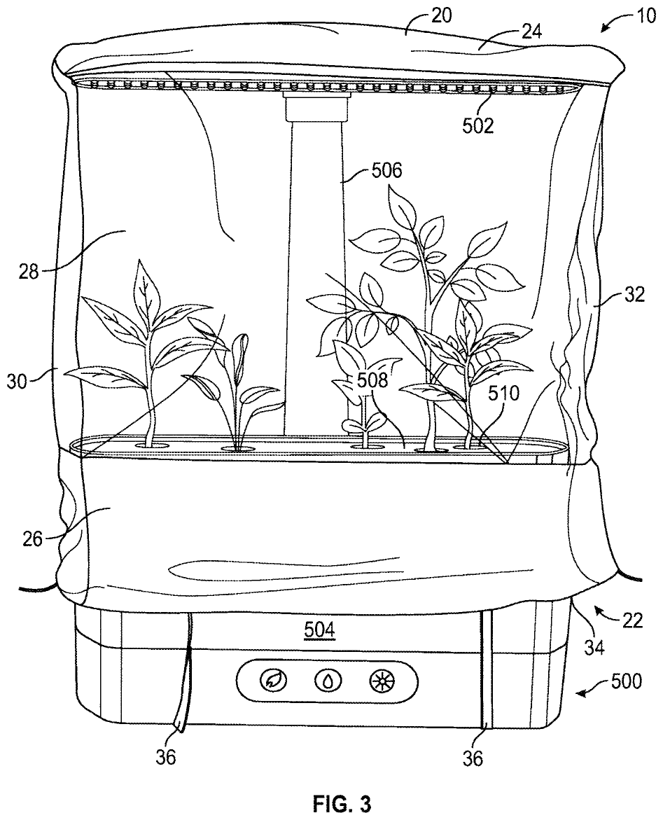

FIG. 3 is a front elevation view of an example embodiment of the cover installed to an exemplary standalone grow unit with the cover rendered transparently for the purposes of illustration.

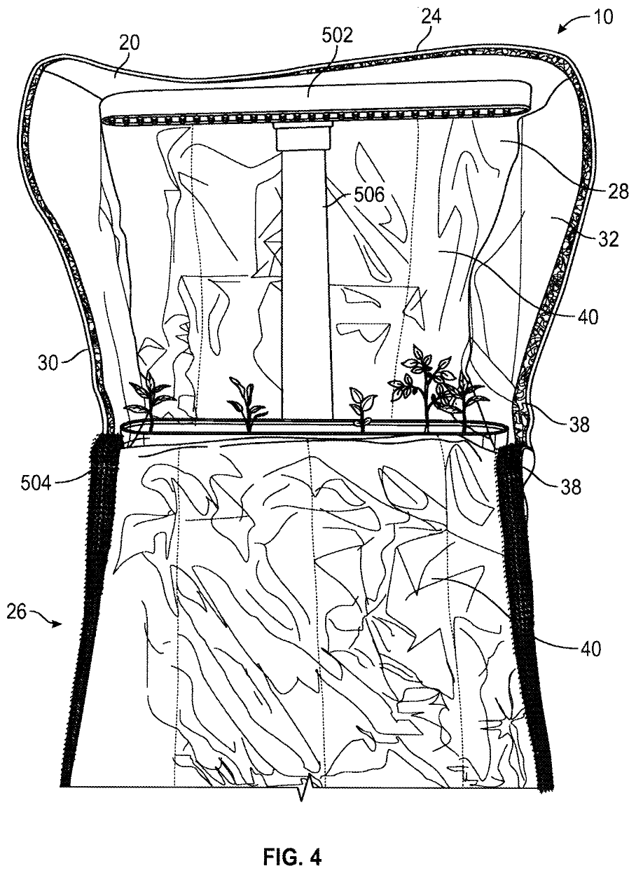

FIG. 4 is a front elevation view of an example embodiment of the cover having an openable seam opened for access to plants grown interior to the cover.

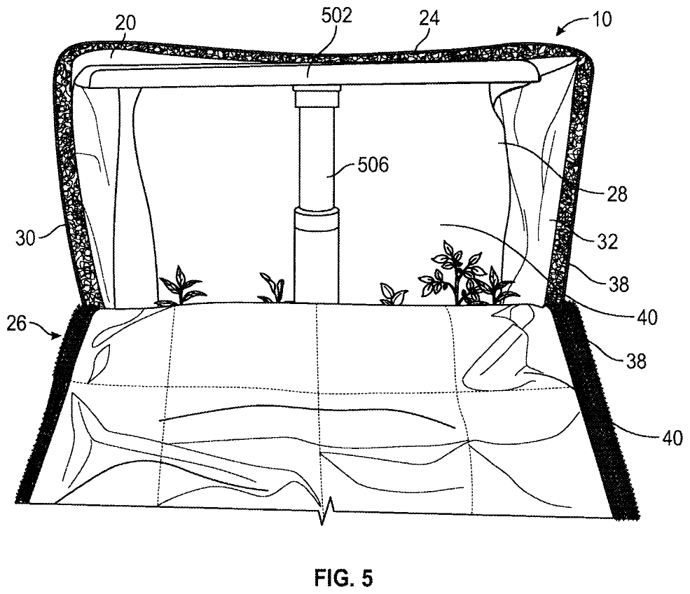

FIG. 5 is a front elevation view of an example embodiment of the cover having an openable seam opened for access to plants grown interior to the cover and showing a lighting array extended vertically.

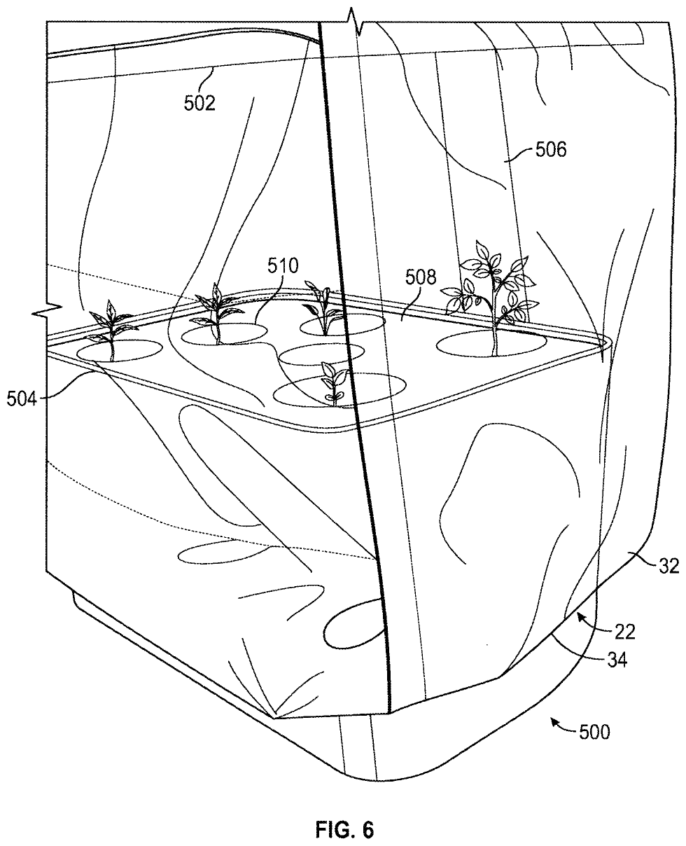

FIG. 6 is a diagonal elevation view showing detail of an example embodiment having an elasticized lower hem member wherein the cover is rendered transparently for the purposes of illustration.

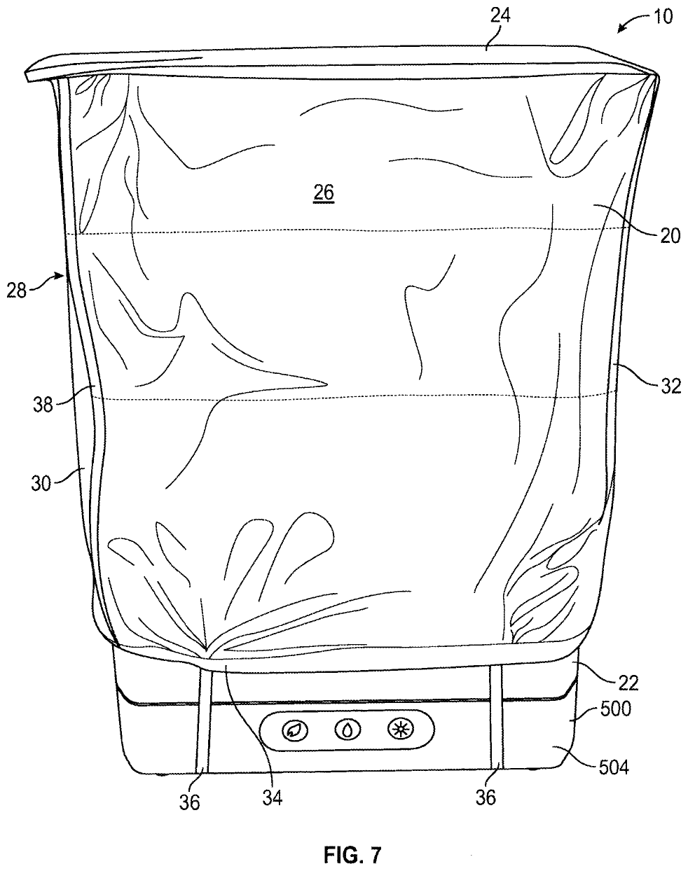

FIG. 7 is a front elevation view of an example embodiment of the cover installed to an exemplary standalone grow unit with a lighting array in a maximally extended position.

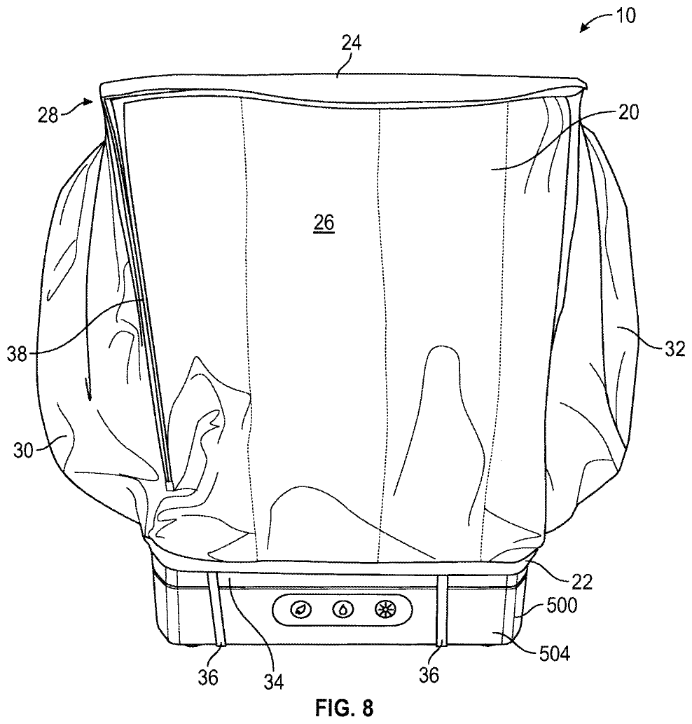

FIG. 8 is a front elevation view of an alternative example embodiment of the instant cover.

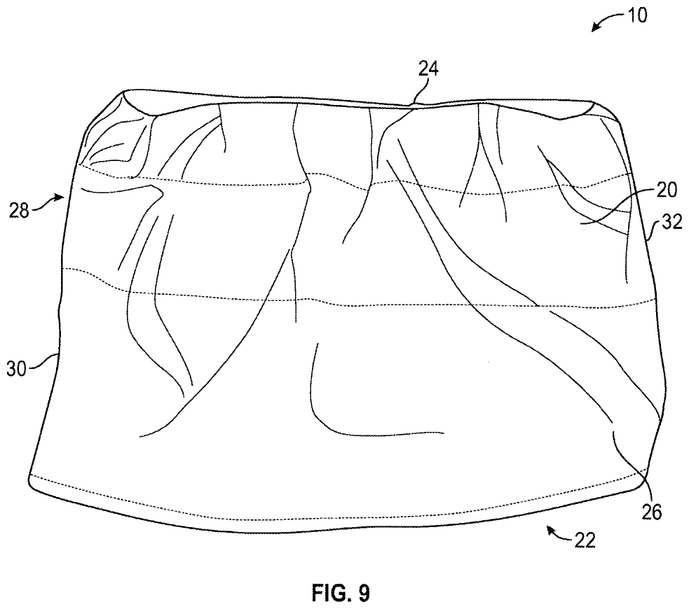

FIG. 9 is a front elevation view of an alternative example embodiment of the to instant cover without an openable seam.

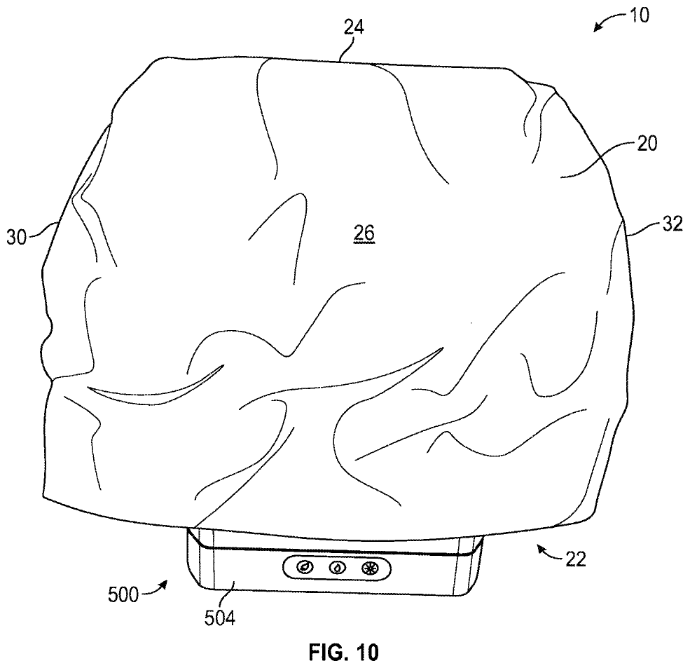

FIG. 10 is a front elevation view of an alternative example embodiment of the instant cover installed overtop a standalone grow unit having the lighting array maximally extended.

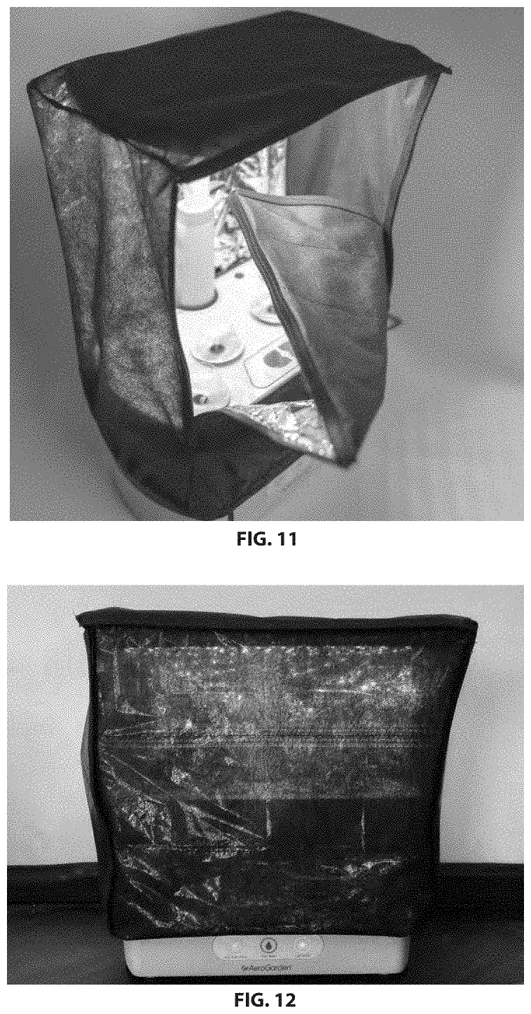

FIG. 11 is a diagonal elevation view photograph of an example embodiment with the openable seam opened. The photograph is included to show the translucence of the fabric matrix through the left and right sides (in this example embodiment).

FIG. 12 is a front elevation view photograph of an example embodiment included to show the translucence of the fabric matrix.

### DETAILED DESCRIPTION OF THE DRAWINGS

The attachable cover for hydroponic or aeroponic grow apparatus is illustrated herein in use with a particular grow unit consistently represented between the accompanying Figures. It is to be understood, however, that the Figures present an example embodiment only, shown in use with the same grow unit for consistency between the Figures and so that the general features of the cover are determinable by persons of ordinary skill in the art. It is not intended that the cover be usable only with grow units of the type shown, the general features of the cover adaptable to fit with really any standalone grow unit of the type produced for small-scale production of vegetables and herbs and other edible plants in or around the home. Thus, the general features depicted in the accompanying Figures are representative only and set forth as example embodiments for the purposes of illustration. No limitations inferable from the drawings are intended.

Turning now to FIG. 1, a front elevation of the breathable reflective cover for hydroponic or aeroponic grow apparatus 10 is shown in use installed upon a standalone grow unit 500. The cover 10 includes a porous fabric matrix 20 having an open bottom 22, a top 24, a front side 26, a rear side 28, a left side 30 and a right side 32, adapted to fit over the grow unit 500 and shield an observer from the illuminance of the lighting array 502 (see, e.g., FIGS. 3 and 4). A lower hem 34 borders and surrounds the open bottom 22. In the example embodiment depicted, the fabric matrix 20 is manufactured from spun polypropylene whereby a taut polymeric weave is accomplished. The fabric weave enables a porosity of the fabric for gaseous exchange with surrounding atmosphere, to control relative humidity and heat, while partially shielding the illuminance emitted interior to the cover 10. The result is a translucence of marked decreased intensity. The interior of the cover 10 remains visible to an exterior observer in muted capacity.

The cover 10 fits overtop the standalone grow unit 500 and, in this example embodiment, is anchored around a base portion 504 of the unit 500 by means of a pair of elasticized members 36 disposed at lower hem 34. The cover 10 is therefore easily added and removed from the standalone grow unit 500 by simply disengaging the elasticized members 36 from around the base portion 504. Once installed to the standalone grow unit 500, the interior of the cover 10 is accessible by means of an openable seam 38 disposed bounding at least two or three sides of the front side 26 of the cover 10 (see, e.g., FIG. 4).

FIG. 2 illustrates an example of the standalone grow unit 500 with which the instant cover 10 is used. This Figure pertains only to prior art preexisting in the market but represents an example embodiment with which the instant cover 10 is adapted for use. It should be understood by persons of ordinary skill in the relevant art that the unit 500 depicted is exemplary only, and is not intended to represent any particular make or model of grow unit, but to illustrate the general features such units exhibit to which the cover is adapted for use. FIG. 2, therefore, illustrates an exemplary standalone grow unit 500 for the purposes of discussion so that the metes and bounds of the present invention 10 may be more easily understood as applicable thereto.

The grow unit 500, therefore, includes a lighting array 502 disposed upon a shaft 506. In some embodiments, the shaft 506 is extendible, to raise the lighting array 502 vertically upwards and accommodate the growth of plants. The plants are grown in receptacles 510 contained within base portion 504 wherein feeding solution or media is also added. Plants thus begin as seedlings with stems and leaves disposed above top surface 508 of base portion 504. Cover 10 therefore is adapted to enclose the space between the lighting array 502 and the base portion 504, to cover and protect the plants (from pets as well as other exterior influences and stresses) as well as to cover the lighting array 502 to subdue exitance of light exterior to the cover 10. Thus, prolonged grow cycles may be employed without emitted light presenting a nuisance to homeowner occupants of interior spaces wherein the grow unit 500 is used.

FIG. 3 is a front elevation view of the exemplary cover 10 in use with the standalone grow unit 500, as shown in FIG. 1, but with the cover 10 rendered transparently to illustrate the position of the grow unit 500 interior to the cover. FIG. 4 is a front elevation view of the exemplary cover 10 in use with the standalone grow unit 500 with an example embodiment of the openable seam 38 opened to access the interior. The openable seam 38 is useful to allow user access for tending to the plants grown inside the cover 10 without the user having to remove the cover 10 from the grow unit 500. In this example embodiment, the openable seam 38 comprises hook and loop fasteners for ease of use—the seam 38 is readily openable and closeable by simple manual pressure to pull the seam 38 apart and re-contact the seam 38 together.

Interior to the cover 10, a reflective surface 40 is illustrated at least disposed upon the interior side of the front and rear sides 26, 28. In this example embodiment, the reflective surface 40 is contemplated to be manufactured from BoPET (Mylar®) to reflect the light around the plants grown inside the cover 10. This is particularly desirable during prolonged use of the grow unit 500 as the lighting array 502 is extended to ensure illuminance upon lower leaves and vegetative growth disposed more proximal the base portion 504 of the grow unit 500. Thus vegetative growth is increased. Access to the interior of the cover 10 is readily effectuated in use of the openable seam 38, and a user is able to tend, nourish, and harvest the plants contained therein, as well as access the base portion 504 or lighting array 502 as needed.

FIG. 5 shows a detail view similar to FIG. 4, an example embodiment of the instant cover 10 in front elevation with the openable seam opened 38. However, in this figure, the standalone unit's lighting array 502 is shown extended upon shaft 506 to raise the lighting array 502 by which to accommodate growth of plants over time.

FIG. 6 is a diagonal elevation view showing an example embodiment of the cover 10 transparently for the purposes of illustration whereby the top surface 508 of the base portion 504 is shown. It should be noted that, in this example embodiment, the left and right sides 30, 32 of the cover 10 are generally translucent. In this example embodiment, there is no reflective interior 40 disposed upon the left and right sides 30, 32. In such example embodiment, porosity of the left and right sides 30, 32 is maintained, to facilitate gaseous exchange with the interior of the cover 10, enable throughflow of atmosphere to control heat and humidity consistent with ambient surroundings, and enable subdued visibility of the interior by a user. However, although not shown in this image (for the purposes of illustrating the interior of the cover 10), a reflective interior 40 may be disposed upon the front and rear sides 26, 28 (as shown in FIGS. 4 and 5, for example).

FIG. 7 is a front elevation view of the cover 10 installed overtop the standalone grow unit 500 when the lighting array 502 is extended. The cover 10 is sized to accommodate the lighting array 502 when moved to the maximally extended position. Thus, the cover 10, once installed, may remain anchored to the grow unit 500 throughout the life cycle of the plants grown therein.

FIG. 8 is a front elevation view of another example embodiment of the instant cover 10 having an openable seam 38 bounding at least two sides of the front side 26. In this example embodiment, the openable seam 38 may include an interlocking seam, a zip-lock seam, a zipper, or other mechanism for effectuating closure of the seam 38.

FIG. 9 is a front elevation view of an example embodiment having an open bottom 22 and disposed to rest overtop the standalone unit 500 without the pair of elasticized members 36 anchoring the cover 10 in position. In such embodiments, it is contemplated that the lower hem 34 may be elasticized to directly engage around the base portion 504. Alternatively, the lower hem 34 may not be elasticized at all, and the cover 10 simply placed overtop the lighting array 502 as needed. FIG. 10 is a front elevation view of the example embodiment illustrated in FIG. 9 shown covering the standalone unit 500 with the lighting array 502 maximally extended (as also shown in FIG. 5).

FIG. 11 is a diagonal elevation view of an example embodiment reduced to practice and shown by photograph. FIG. 11 is included for the purposes of demonstrating the translucence of the fabric matrix 20. The interior of the cover can be seen through the left side in this example embodiment, demonstrating the porosity of the spun polypropylene in this embodiment. FIG. 12 is a front elevation view of another example embodiment reduced to practice and also included for the purposes of demonstrating the translucence of the fabric matrix.

What is claimed is:

1. A breathable reflective cover for hydroponic or aeroponic grow apparatus comprising:
a porous fabric matrix having an open bottom, said matrix configured for releasable attachment covering at least a majority of the grow apparatus, said matrix comprising:
a top;
a front side having a reflective surface interiorly disposed thereupon;
a rear side having a reflective surface interiorly disposed thereupon;
a left side;
a right side; and
a lower hem surrounding the open bottom;
wherein the cover is positional covering the existing grow apparatus and the fabric enables permeability of atmosphere therethrough while enclosing the grow apparatus to contain the luminosity of the grow apparatus and reflect the emitted light around plants grown therein.

2. The breathable reflective cover for hydroponic or aeroponic grow apparatus of claim 1 wherein the left side and the right side have a reflective surface interiorly disposed thereupon.

3. The breathable reflective cover for hydroponic or aeroponic grow apparatus of claim 1 further comprising at least one elasticized member disposed in operational communication with the open bottom, said at least one elasticized member disposed to tautly engage the matrix in position anchored covering the existing grow apparatus.

4. The breathable reflective cover for hydroponic or aeroponic grow apparatus of claim 1 further comprising an openable seam disposed bounding the front side, said openable seam configured to enable access to the existing grow apparatus over which the cover is installed when the seam is opened.

5. The breathable reflective cover for hydroponic or aeroponic grow apparatus of claim 2 wherein the fabric matrix is comprised of spun polypropylene and the reflective surface is comprised of BoET (mylar).

6. The breathable reflective cover for hydroponic or aeroponic grow apparatus of claim 5 further comprising fabric folded or ruffled proximal the open bottom wherein the cover is expansible to accommodate vertical extension of a lighting array in use of the grow apparatus.

7. The breathable reflective cover for hydroponic or aeroponic grow apparatus of claim 4 wherein the fabric matrix is comprised of spun polypropylene and the reflective surface is comprised of BoPET (mylar).

8. The breathable reflective cover for hydroponic or aeroponic grow apparatus of claim 7 further comprising fabric folded or ruffled proximal the open bottom wherein the cover is expansible to accommodate vertical extension of a lighting array in use of the grow apparatus.

9. A breathable reflective cover for hydroponic or aeroponic grow apparatus comprising:
a porous fabric matrix having an open bottom, said matrix configured for releasable attachment covering at least a majority of the grow apparatus, said matrix comprising:
a top;
a front side having a reflective surface interiorly disposed thereupon;
a rear side having a reflective surface interiorly disposed thereupon;
a left side;
a right side;
an openable seam disposed bounding the front side, said openable seam configured to enable access to the existing grow apparatus over which the cover is installed when the seam is opened;
a lower hem surrounding the open bottom; and
at least one elasticized member disposed in operational communication with the open bottom, said at least one elasticized member disposed to tautly engage the matrix in position anchored covering the existing grow apparatus;
wherein the cover is securable covering the existing grow apparatus and the fabric enables permeability of atmosphere therethrough while enclosing the grow apparatus to contain the luminosity of the grow apparatus and reflect the emitted light around plants grown therein.

10. The breathable reflective cover for hydroponic or aeroponic grow apparatus of claim 9 wherein the at least one elasticized member includes at least a pair of elasticized members disposed as loops perpendicularly interconnecting the lower hem from the front side to the rear side.

11. The breathable reflective cover for hydroponic or aeroponic grow apparatus of claim 9 wherein the at least one elasticized member is disposed interiorly to the lower hem whereby the hem elastically engages around a base of the existing grow apparatus.

12. The breathable reflective cover for hydroponic or aeroponic grow apparatus of claim 9 wherein the openable seam is openable and closable by action of hook and loop.

13. The breathable reflective cover for hydroponic or aeroponic grow apparatus of claim 10 wherein each reflective surface is BoPET (mylar).

14. The breathable reflective cover for hydroponic or aeroponic grow apparatus of claim 13 wherein the fabric matrix comprises spun polypropylene.

15. The breathable reflective cover for hydroponic or aeroponic grow apparatus of claim 14 wherein the openable seam is openable and closable by action of hook and loop.

16. The breathable reflective cover for hydroponic or aeroponic grow apparatus of claim 9 further comprising fabric folded or ruffled proximal the open bottom wherein the cover is expansible to accommodate vertical extension of a lighting array in use of the grow apparatus.
